(19) United States
(12) Patent Application Publication
(10) Pub. No.: US 2011/0137861 A1
(43) Pub. Date: Jun. 9, 2011

(54) Methods for Achieving Efficient Coherent Access to Data in a Cluster of Data Processing Computing Nodes

(75) Inventors: Rodney C. Burnett, Austin, TX (US); David A. Elko, Austin, TX (US); Ronen Grosman, Thornhill (CA); Jimmy R. Hill, Austin, TX (US); Matthew A. Huras, Ajax (CA); Mark A. Kowalski, Austin, TX (US); Daniel H. Lepore, Austin, TX (US); Keriley K. Romanufa, Scarborough (CA); Aamer Sachedina, Queensville (CA); Xun Xue, Markham (CA)

(73) Assignee: INTERNATIONAL BUSINESS MACHINES CORPORATION, Armonk, NY (US)

(21) Appl. No.: 12/634,463

(22) Filed: Dec. 9, 2009

(51) Int. Cl. G06F 17/00; G06F 15/167

(52) U.S. Cl. 707/622; 709/212; 707/E17.005

(57) ABSTRACT

A coherency manager provides coherent access to shared data by receiving a copy of updated database data from a host computer through RDMA, the copy including updates to a given database data; storing the copy of the updated database data as a valid copy of the given database data in local memory; invalidating local copies of the given database data on other host computers through RDMA; receiving acknowledgements from the other host computers through RDMA that the local copies of the given database data have been invalidated; and sending an acknowledgement of receipt of the copy of the updated database data to the host computer through RDMA. When the coherency manager receives a request for the valid copy of the given database data from a host computer through RDMA, it retrieves the valid copy of the given database data from the local memory and returns the valid copy through RDMA.

### BACKGROUND

Cluster database systems run on multiple host computers. A client can connect to any of the host computers and see a single database. Shared data cluster database systems provide coherent access from multiple host computers to a shared copy of data. Providing this coherent access to the same data across multiple host computers inherently involves performance compromises. For example, consider a scenario where a given database data is cached in the memory of two or more of the host computers in the cluster. A transaction running on a first host computer changes its copy of the given database data in memory and commits the transaction. At the next instant in time, another transaction starts on a second host computer, which reads the same given database data. For the cluster database system to function correctly, the second host computer must be ensured to read the database data as updated by the first host computer.

Many existing approaches to ensuring such coherent access to shared data involves a messaging protocol. However, messaging protocols require overhead associated with processor cycles to process the messages and in communication bandwidth for the sending of the messages. Some systems avoid using messaging protocols through use of specialized hardware that reduces or eliminates the need for messages. However, for systems without such specialized hardware, this approach is not possible.

### BRIEF SUMMARY

According to one embodiment of the present invention, a coherency manager provides coherent access to shared data in a shared database system by: determining that remote direct memory access (RDMA) operations are supported in the shared database system; receiving a copy of updated database data from a first host computer in the shared database system through RDMA, the copy of the updated database data comprising updates to a given database data; storing the copy of the updated database data as a valid copy of the given database data in local memory; invalidating local copies of the given database data on other host computers in the shared database system through RDMA; receiving acknowledgements from the other host computers through RDMA that the local copies of the given database data have been invalidated; and sending an acknowledgement of receipt of the copy of the updated database data to the first host computer through RDMA.

In one embodiment, the coherency manager receives a request for the valid copy of the given database data from a second host computer in the shared database system through RDMA; retrieves the valid copy of the given database data from the local memory; and returns the valid copy of the given database data to the second host computer through RDMA.

In one embodiment, the coherency manager determines that RDMA operations are not supported in the shared database system; receives one or more messages comprising copies of a plurality of updated database data from a first host computer, where the copies of the plurality of updated database data comprises updates to a plurality of given database data; stores the copies of the plurality of updated database data as valid copies of the plurality of given database data in local memory; sending a single message to the other host computers invalidating local copies of the plurality of given database data on the other host computers; receives acknowledgement messages from the other host computers that the local copies of the plurality of given database data have been invalidated; and sends an acknowledgement message of receipt of the copies of the plurality of updated database data to the first host computer.

In one embodiment, a host computer updates a local copy of a given database data; determines a popularity of the given database data; in response to determining that the given database data is unpopular, sending updated database data identifiers only to a coherency manager through RDMA; and in response to determining that the given database data is popular, sending the updated database data identifiers and a copy of the updated database data to the coherency manager through RDMA.

System and computer program products corresponding to the above-summarized methods are also described herein.

### BRIEF DESCRIPTION OF THE SEVERAL VIEWS OF THE DRAWINGS

FIG. 1 illustrates an example of an existing approach to ensuring coherent access to shared database data using a messaging protocol.

FIG. 2 illustrates an embodiment of a cluster database system utilizing an embodiment of the present invention.

FIG. 3 is a flowchart illustrating an embodiment of a method for providing coherent access to shared data in a cluster database system.

FIG. 4 illustrates the example of FIG. 1 using am embodiment of the method for ensuring coherent access to shared database data according to the present invention.

FIG. 5 is a flowchart illustrating an embodiment of the method of the present invention for ensuring that the RDMA operations fully complete with respect to the memory hierarchy of the host computers.

FIG. 6 is a flowchart illustrating an embodiment of the invalidate-at-commit protocol according to the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java, and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

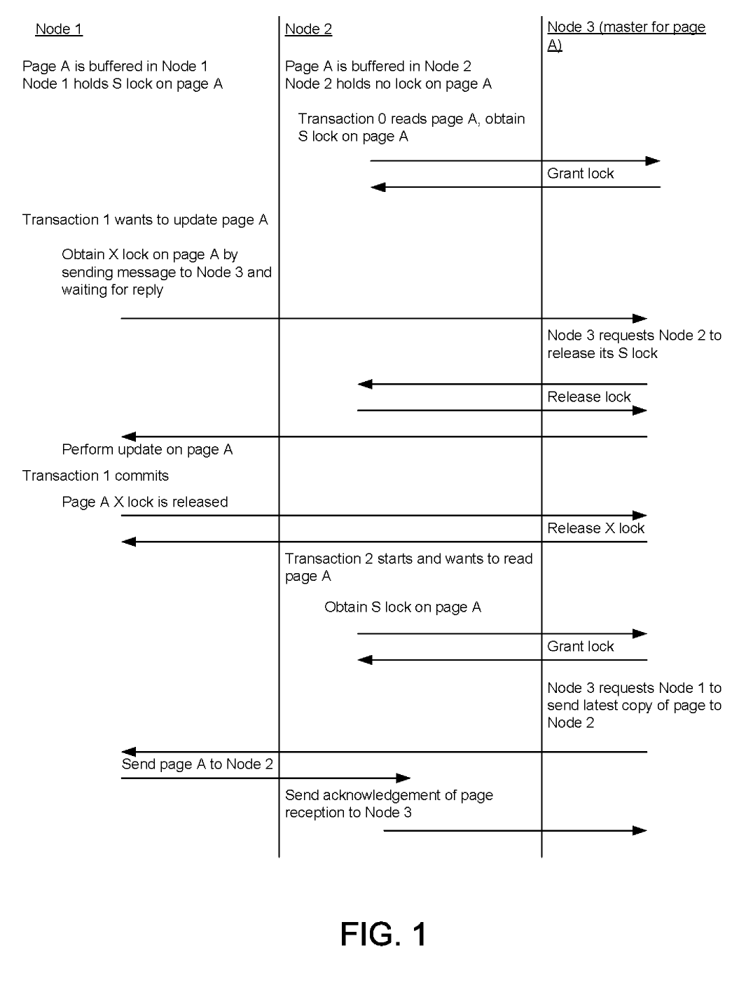

FIG. 1 illustrates an example of an existing approach to ensuring coherent access to shared database data using a messaging protocol. Data are stored in the database in the form of tables. Each table includes a plurality of pages, and each page includes a plurality of rows or records. In the illustrated example, the cluster database system contains a plurality of host computers or nodes. Assume that the local bufferpools of Nodes 1 and 2 both contain a copy of page A and that Node 3 is the master for page A. Node 1 holds a shared (S) lock on page A, while Node 2 holds no lock on page A. In transaction 0, Node 2 reads page A and obtains an S lock on page A. Obtaining the S lock involves the exchange of messages with Node 3 for the requesting and granting of the S lock. In transaction 1, Node 1 wants to update page A and sends a message to Node 3 requesting an exclusive (X) lock on page A. In response, Node 3 exchanges messages with Node 2 for the requesting and releasing of the S lock on page A. Once released, Node 3 sends a message to Node 1 granting the X lock. Node 1 commits transaction 1 and releases the X lock on page A by exchanging messages with Node 3. In transaction 2, Node 2 wants to read page A and obtains an S lock on page A by exchanging messages with Node 3 for the requesting and granting of the S lock. Node 3 sends a message to Node 1 to send the latest copy of page A to Node 2. Node 1 responds by sending a message to Node 2 with the latest copy of the page A. Node 2 then sends a message acknowledging receipt of the latest copy of page A to Node 3.

As illustrated, the process to ensure that Node 2 reads the latest copy of the page in transaction 2 requires numerous messages to be exchanged between Nodes 1, 2, and 3. The messages require communication bandwidth, as well as requiring central processing unit (CPU) cycles at each node to process the messages it receives. The volume of such messages could significantly impact overhead requirements on the database system and affect performance.

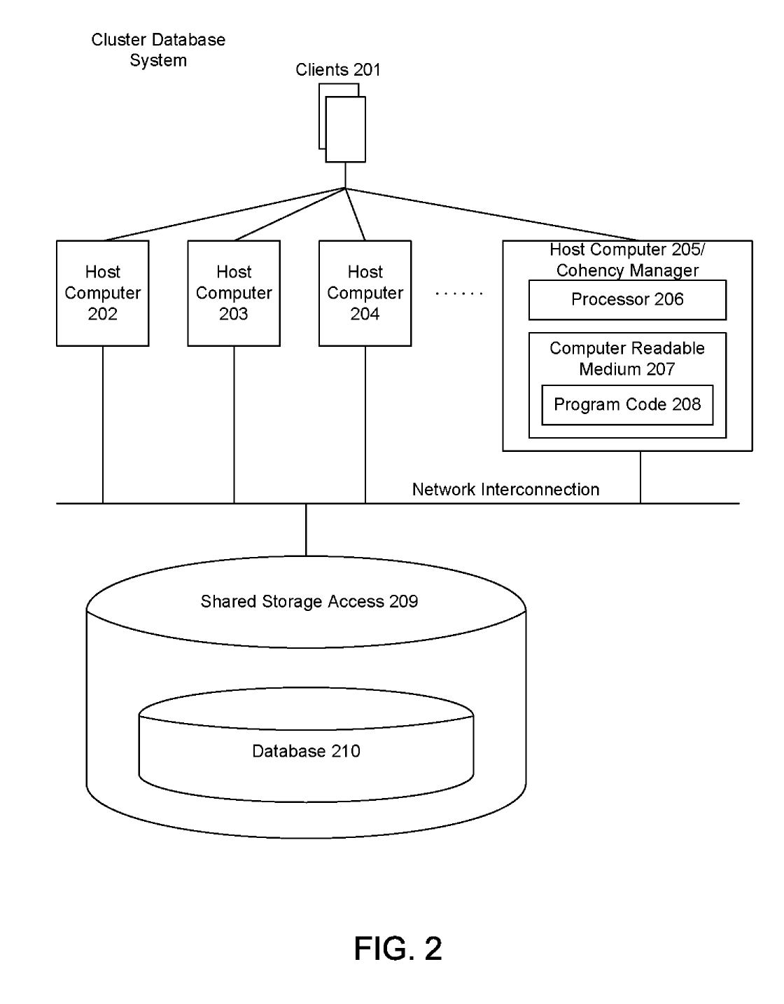

Embodiments of the present invention reduce the messages required to ensure coherent access to shared copies of database data through the use of a Coherency Manager. FIG. 2 illustrates an embodiment of a cluster database system utilizing an embodiment of the present invention. The system includes a plurality of clients 201 operatively coupled to a cluster of host computers 202-205. The host computers 202-205 co-operate with each other to provide coherent shared storage access 209 to the database 210 from any of the host computers 202-205. Data are stored in the database in the form of tables. Each table includes a plurality of pages, and each page includes a plurality of rows or records. The clients 201 can connect to any of the host computers 202-205 and see a single database.

Each host computer 202-205 is operatively coupled to a processor 206 and a computer readable medium 207. The computer readable medium 207 stores computer readable program code 208 for implementing the method of the present invention. The processor 206 executes the program code 208 to ensure coherency access to shared copies of database data across the host computers 202-205, according to the various embodiments of the present invention.

The Coherency Manager provides centralized page coherency management, and may reside on a distinct computer in the cluster or on a host computer which is also performing database processing, such as host computer 205. The Coherency Manager 205 provides database data coherency by leveraging standard remote direct memory access (RDMA) protocols, using intelligent selection between a force-at-commit protocol and an invalidate-at-commit protocol, and for using a batch protocol for data invalidation when RDMA is not available, as described further below. RDMA is a direct memory access from the memory of one computer into that of another computer without involving either computer's operating systems. RDMA allows for the transfer of data directly to or from the memories of two computers, eliminating the need to copy data between application memory and the data buffers in the operating system. Such transfers do not require work to be done by the CPU's or caches.

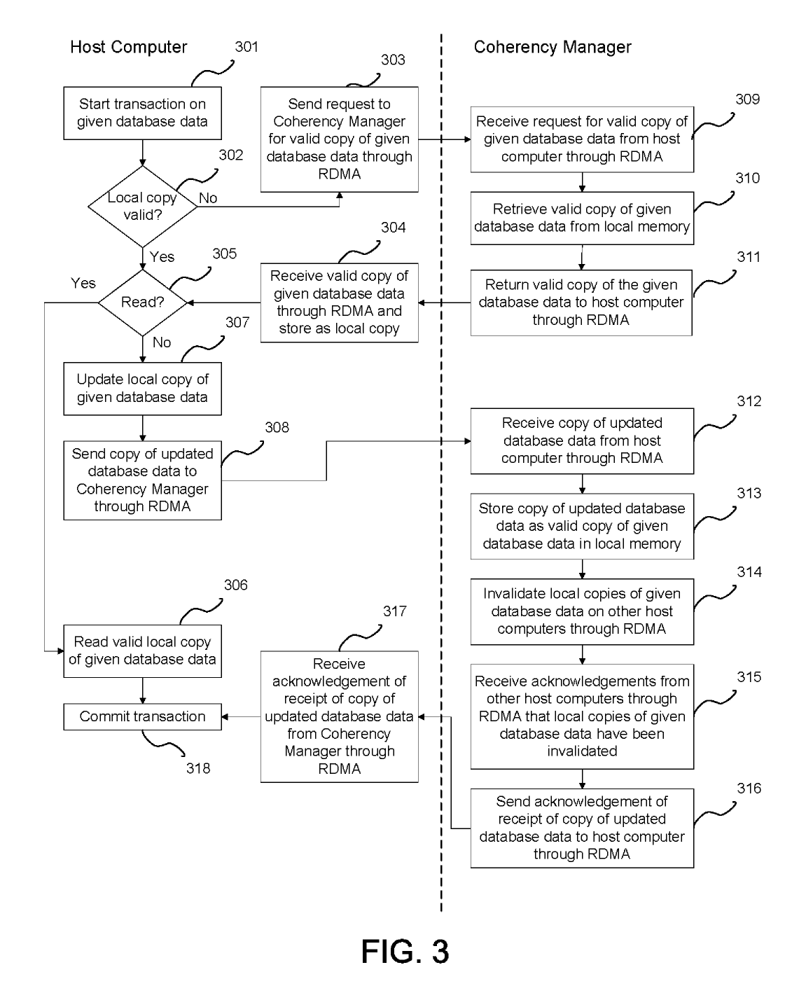

FIG. 3 is a flowchart illustrating an embodiment of a method for providing coherent access to shared data in a cluster database system. A host computer (such as host computer 202) starts a transaction on a given database data (301). The host computer 202 determines if the local copy of the given database data in its local bufferpool is valid (302). In a preferred embodiment, the validities of local copies of database data are stored in memory local to the host computer 202, and the validity of the given database data can be determined by examining this local memory.

If the local copy of the given database data is not valid, the host computer 202 sends a request to the Coherency Manager 205 for a valid copy of the given database data through RDMA (303). The Coherency Manager 205 receives the request for the valid copy of the given database data from the host computer 202 through RDMA (309), retrieves the valid copy of the given database data from its local memory (310), and returns the valid copy of the given database data to the host computer 202 through RDMA (311).

The host computer 202 receives the valid copy of the given database data from the Coherency Manager 205 and stores it as the local copy (304). If the transaction is to read the given database data (305), then the host computer 202 reads the valid local copy of the given database data (306) and commits the transaction (308). Otherwise, the host computer 202 updates the local copy of the given database data (307). The host computer 202 then sends a copy of the updated database data to the Coherency Manager 205 through RDMA (308). The Coherency Manager 205 receives the copy of the updated database data from the host computer 202 through RDMA (312), and stores the copy of the updated database data as the valid copy of the given database data in local memory (313). The Coherency Manager 205 then invalidates the local copies of the given database data on the other host computer 203-204 in the cluster database system containing a copy through RDMA (314). When the Coherency Manager 205 receives acknowledgements from the other host computers 202-204 through RDMA that the local copies of the given database data have been invalidated (315), the Coherency Manager 205 sends an acknowledgement of receipt of the copy of the updated database data to the host computer 202 through RDMA (316). The host computer 202 receives the acknowledgement of receipt of the copy of the updated database data from the Coherency Manager 205 through RDMA (317), and in response, commits the transaction (318). This mechanism is referred to herein as a “force-at-commit” protocol. Once the transaction commits, any lock on the given database data owned by the host computer 202 is released.

When another host computer wishes to access the given database data during another transaction, steps 301-318 are repeated.

The force-at-commit protocol described above allows the Coherency Manager 205 to invalidate any copies of the database data that exist in the buffers of other host computers 203-204 before the transaction at the host computer 202 commits. The force-at-commit protocol furthers allows the Coherency Manager to maintain a copy of the updated database data, such that future requests for the database data from any host computer in the system can be efficiently provided directly from the Coherency Manager 205 without using a messaging protocol.

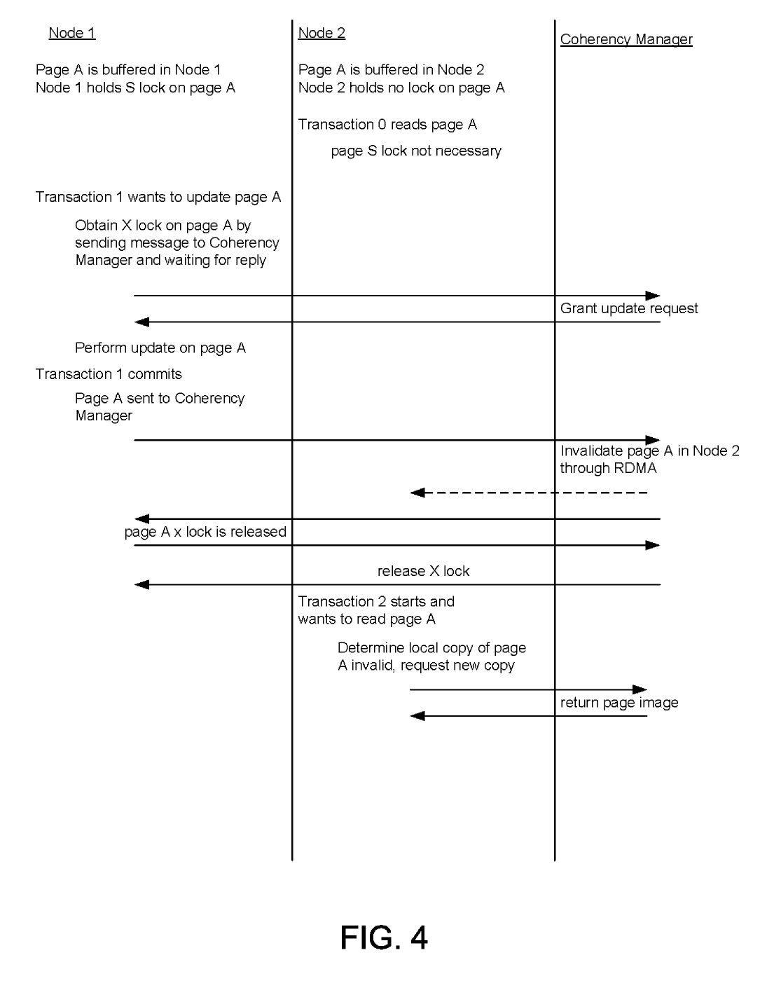

FIG. 4 illustrates the example of FIG. 1 using an embodiment of the method for ensuring coherent access to shared database data according to the present invention. In this illustrated example, assume that the local bufferpools of Nodes 1 and 2 both contain a copy of page A. Node 1 holds an S lock on page A, while Node 2 holds no lock on page A. In transaction 0, Node 2 reads page A, for which no S lock is necessary. In transaction 1, Node 1 wants to update page A and obtains an X lock on page A by exchanging messages with the Coherency Manager 205. Node 1 performs the update on page A (301-307, FIG. 3). Assume here that the local copy of page A at Node 1 was determined to be valid, and thus no request for a valid copy from the Coherency Manager 205 is required. Before transaction 1 commits, a copy of updated page A is sent to the Coherency Manager through RDMA (308). In response, the Coherency Manager 205 invalidates the local copy of page A in Node 2, as well as other nodes in the system containing a copy of page A, through RDMA (312-316). Once Node 1 receives the acknowledgement of receipt of the copy of page A from the Coherency Manager 205 through RDMA (317), Node 1 commits transaction 1 (318) and releases the X lock on page A by exchanging messages with the Coherency Manager 205.

Assume that Node 2 starts transaction 2 and wants to read page A (301). Node 2 determines that the local copy of page A is invalid (302). Node 2 then sends a request to the Coherency Manager 205 for a valid copy of page A through RDMA, and receives the valid copy of page A from the Coherency Manager 205 through RDMA (303-304). Node 2 reads the valid copy of page A and commits the transaction (305-306, 318). Node 2 is thus assured to read the latest copy of page A. As can be seen by comparing FIGS. 1 and 4, the number of messages has been significantly reduced.

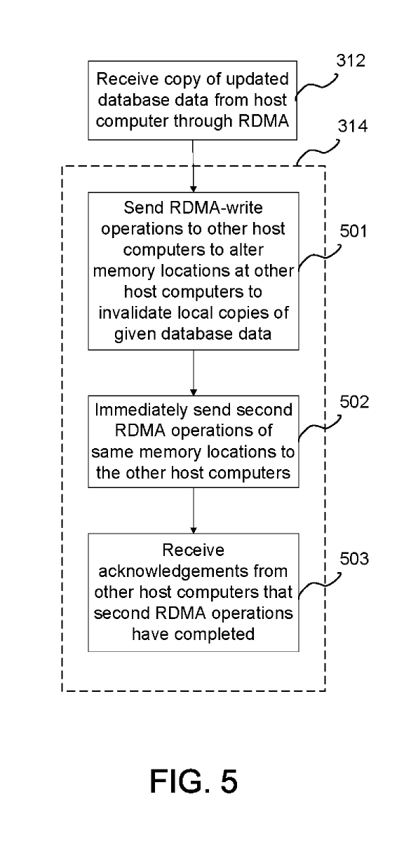

During the invalidation of step 314, the RDMA operations must fully complete with respect to the memory hierarchy of the host computers 203-204 before the Coherency Manager 205 acknowledges receipt in step 316. The RDMA protocol updates the memories at the host computer 203-204 but not the cache, such as the Level 2 caches of the CPU's. Thus, it is possible for an RDMA operation to invalidate a local copy of database data in memory but fail to invalidate a copy of the database data in cache. This would lead to incoherency of the data. To ensure that the RDMA operations fully complete with respect to the memory hierarchy of the host computers, the method of the present invention leverages existing characteristics of the RDMA protocol during the invalidation (314), as illustrated in FIG. 5.

FIG. 5 is a flowchart illustrating an embodiment of the method of the present invention for ensuring that the RDMA operations fully complete with respect to the memory hierarchy of the host computers. In this embodiment, in response to receiving a copy of the updated database data from the host computer 202 through RDMA (312), the Coherency Manager 205 sends RDMA-write operations to the other host computers 203-204 to alter memory locations at the other host computers 203-204 to invalidate the local copies of the given database data (501). Immediately after, the Coherency Manager 205 sends second RDMA operations of the same memory locations to the other host computers 203-204 (502). Herein, “immediately after” refers to the sending of the RDMA-write operations and the second RDMA operations very close in time and without any RDMA operations being sent in-between. The Coherency Manager 205 then receives acknowledgements from the other host computer 203-204 that the second RDMA operations have completed (503).

In one embodiment, the RDMA-write operations are immediately followed by RDMA-read operations of the same memory locations. In another embodiment, the RDMA-write operations are immediately followed by another set of RDMA-write operations of the same memory locations. Open RDMA protocols generally require that for the RDMA-read or RDMA-write operation to complete, any prior RDMA-write operations to the same location must have fully completed with respect to the memory coherency domain on the target computer. Thus, sending RDMA-read or RDMA-write operations to the same memory locations immediately after the RDMA-write operations ensures that no copies in the cache at the host computers 203-204 would erroneously remain valid.

Thus, once the acknowledgements that the second RDMA operations have completed are received from the other host computers 203-204, the Coherency Manager 205 is assured that the invalidation of the local copies of the given database data at the host computers 203-204 are complete in the entire memory hierarchy in the host computers 203-204.

Alternatively, some RDMA-capable adapters include a ‘delayed ack’ feature. The ‘delayed ack’ feature does not send an acknowledgement of an RDMA-write operation until the operation is fully complete. This ‘delayed ack’ feature can thus be leveraged to ensure that the invalidation of the local copies of the given database data are complete in the entire memory hierarchy in the host computers 203-204.

To optimize the method according to the present invention, several techniques can be used in conjunction with the RDMA operations described above. One technique includes the parallel processing of the RDMA invalidations. In the parallel processing, for any given database data that requires invalidation, the Coherency Manager 205 first initiates all RDMA operations to the other host computers containing a local copy of the database data. Then, the Coherency Manager 205 waits for the acknowledgements from each host computer 203-204 that the RDMA has completed before proceeding. For example, when used in conjunction with the RDMA-write operation followed by the RDMA-read approach described above, both RDMA operations are initiated for all of the other host computers 203-204, then all of the acknowledgements of the RMDA operations are collected from the other host computers 203-204 before the Coherency Manager 205 proceeds.

In another technique, multi-casting is used in conjunctions with the RDMA operations described above. Instead of sending separate, explicit RDMA operations to each host computer 203-204, the Coherency Manager 205 uses a single multi-cast RDMA operation to the host computers 203-204 with a copy of the database data to be invalidated. Thus, one multi-cast RDMA operation is used to accomplish invalidations on the host computers 203-204.

In another embodiment of the method of the present invention, a further optimization is through the intelligent selection by the host computer 202 between the force-at-commit protocol described above and an “invalidate-at-commit” protocol. In the invalidate-at-commit protocol, the identifiers of the updated database data are sent to the Coherency Manager 205, but a copy of the updated database data itself is not. In this embodiment, the selection is based on the “popularity”, or frequency of accesses, of the given database data being updated. Database data that are frequently referenced by different host computers in the cluster are “popular” while database data that are infrequently referenced are “unpopular”. The sending of a copy of updated database data that are unpopular may waste communication bandwidth and memory. Such unpopular database data may not be requested by other host computers in the cluster before the data is removed from memory by the Coherency Manager 205 in order to make room for more recently updated data. Accordingly, for data that are determined to be “unpopular”, an embodiment of the present invention uses an invalidate-at-commit protocol.

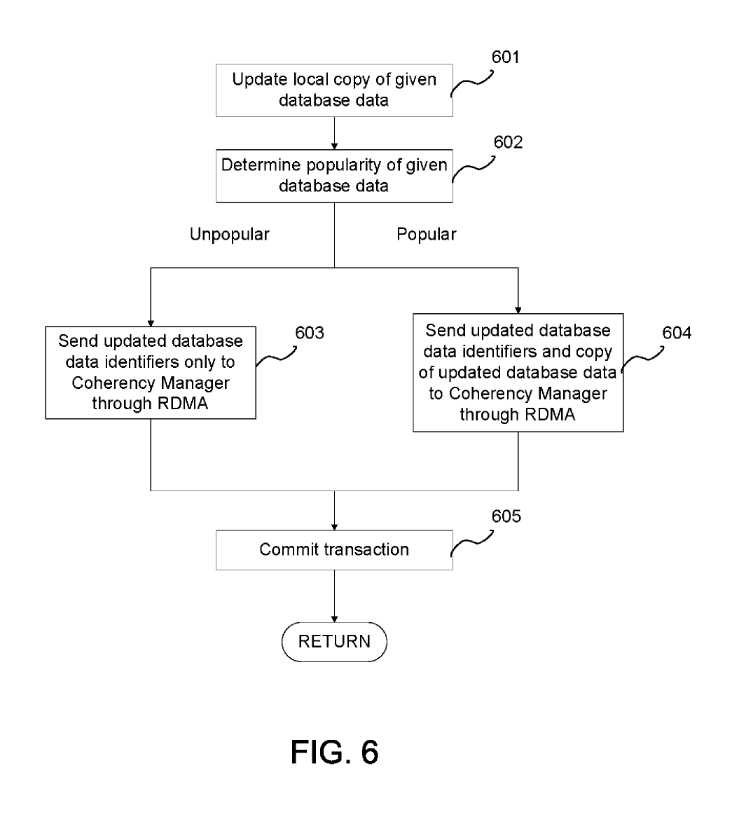

FIG. 6 is a flowchart illustrating an embodiment of the invalidate-at-commit protocol according to the present invention. A host computer 202 updates its local copy of a given database data (601) and determines the popularity of the given database data (602). In response to determining that the given database data is “unpopular”, the host computer 202 uses the invalidate-at-commit protocol and sends the updated database data identifiers only to the Coherency Manager 205 through RDMA (603). The updated database data itself is not sent to the Coherency Manager 205. In response to determining that the given database data is “popular”, the host computer 202 uses the force-at-commit protocol (described above with FIG. 3) and sends the updated database data identifiers and a copy of the updated database data to the Coherency Manager 205 through RDMA (604). Once the host computer 202 receives the appropriate acknowledgement from the Coherency Manager 205, the transaction commits (605).

With the invalidate-at-commit protocol, the Coherency Manager 205 is still able to invalidate the local copies of the given database data at other host computer 203-204 using the updated database data identifiers but is not required to store a copy of the updated database data itself. When a host computer later requests a copy of the updated database data, the Coherency Manager 205 can request the valid copy from the host computer 202 that updated the database data and return the valid copy to the requesting host computer. For workloads involving random access to data, this can provide a significant savings in communication bandwidth costs.

Various mechanisms can be used to determine the popularity of database data. One embodiment leverages the fact that database data in a host computer's local bufferpool are periodically written to disk. When a host computer updates a given database data, at commit time, the host computer determines if the database data was originally stored into the local bufferpool via a reading of the database data directly from disk. If so, this means that no other host computer in the cluster requested the database data between writings from the bufferpool to disk. Thus, the database data is determined to be “unpopular,” and the host computer uses the invalidate-at-commit protocol. If the host computer determines that the database data was originally stored into the local bufferpool via a reading of the database data from the Coherency Manager 205, then this means that there was at least one other host computer in the cluster that requested the database data between writings from the bufferpool to disk. Thus, the database data is determined to be “popular”, and the host computer uses the force-at-commit protocol. Other mechanisms for determining the popularity of database data may be used without departing from the spirit and scope of the present invention.

Some communications fabrics of cluster database systems do not support RDMA operations. On such fabrics, an embodiment of the present invention increases the efficiency of coherent data access by amortizing multiple separate invalidations for different database data in the same message. For example, Node 1 may execute and commit ten transactions updating twenty pages. Node 2 has all twenty pages buffered. Instead of sending twenty individual page invalidation messages, the Coherency Manager 205 sends a single message to node 2 containing the identifiers for all twenty pages. When node 2 receives and processes the message, node 2 invalidates all twenty pages in its local buffer before replying to the Coherency Manager 205 with an acknowledgement. Thus, instead of expending CPU cycles to process twenty invalidation messages, node 2 only expends CPU cycles to process one message.

Further efficiency can be realized when multi-cast is available. When a set of pages needs to be invalidated, and these pages are buffered in more than one host computer, multi-cast can be used by the Coherency Manager 205 to send a single invalidate message for all of the pages.

What is claimed is:

1. A method for providing coherent access to shared data in a shared database system, the shared database system including a plurality of host computers, comprising:
receiving by a coherency manager data indicating updates of a given database data from a first host computer in the shared database system through remote direct memory access (RDMA);
invalidating by the coherency manager local copies of the given database data on other host computers in the shared database system through RDMA;
receiving acknowledgements by the coherency manager from the other host computers through RDMA that the local copies of the given database data have been invalidated; and
sending by the coherency manager an acknowledgement of receipt of the data indicating the update of the given database data to the first host computer through RDMA.

2. The method of claim 1, wherein the receiving by the coherency manager data indicating the updates of the given database data comprises:
receiving by the coherency manager a copy of updated database data from the first host computer in the shared database system through RDMA, the copy of the updated database data comprising the updates to the given database data; and
storing by the coherency manager the copy of the updated database data as a valid copy of the given database data in local memory.

3. The method of claim 2, further comprising:
receiving by the coherency manager a request for the valid copy of the given database data from a second host computer in the shared database system through RDMA;
retrieving by the coherency manager the valid copy of the given database data from the local memory; and
returning by the coherency manager the valid copy of the given database data to the second host computer through RDMA.

4. The method of claim 1, wherein the invalidating by the coherency manager the local copies of the given database data on the other host computers in the shared database system through RDMA comprises:
sending by the coherency manager RDMA-write operations to the other host computers to alter memory locations at the other host computers to invalidate the local copies of the given database data;
immediately sending to the other host computers by the coherency manager second RDMA operations of the same memory locations at the other host computers; and
receiving by the coherency manager acknowledgements from the other host computers that the second RDMA operations have completed.

5. The method of claim 4, wherein the immediately sending to the other host computers by the coherency manager the second RDMA operations of the same memory locations at the other host computers comprises:
immediately sending to the other host computers by the coherency manager RDMA-read operations to the same memory locations at the other host computers.

6. The method of claim 4, wherein the immediately sending to the other host computers by the coherency manager the second RDMA operations of the same memory locations at the other host computers comprises:
immediately sending to the other host computers by the coherency manager second RDMA-write operations to the same memory locations at the other host computers.

7. The method of claim 1, wherein the invalidating by the coherency manager the local copies of the given database data on the other host computers in the shared database system through RDMA comprises:
determining a delayed acknowledgement feature is supported by the shared database system; and
sending by the coherency manager RDMA-write operations to the other host computers to alter memory locations at the other host computers to invalidate the local copies of the given database data,
wherein the delayed acknowledgement feature at the other host computers allows the sending of acknowledgements to the coherency manager only after the RDMA-write operations fully complete in entire memory hierarchies of the other host computers.

8. The method of claim 4,
wherein the sending by the coherency manager the RDMA-write operations to the other host computers to alter the memory locations at the other host computers to invalidate the local copies of the given database data comprises:
sending in parallel by the coherency manager the RDMA-write operations to the other host computers to alter the memory locations at the other host computers to invalidate the local copies of the given database data,
wherein the immediately sending to the other host computers by the coherency manager the second RDMA operations of the same memory locations at the other host computers comprises:
immediately sending in parallel to the other host computers by the coherency manager the second RDMA operations of the same memory locations at the other host computers.

9. The method of claim 4, wherein the sending by the coherency manager the RDMA-write operations to the other host computers to alter the memory locations at the other host computers to invalidate the local copies of the given database data comprises:
sending a multi-cast RDMA-write operation by the coherency manager to the other host computers to alter the memory locations at the other host computers to invalidate the local copies of the given database data.

10. The method of claim 1, further comprising:
determining that RDMA operations are not supported in the shared database system;
receiving by the coherency manager one or more messages comprising copies of a plurality of updated database data from a first host computer, wherein the copies of the plurality of updated database data comprises updates to a plurality of given database data;
storing by the coherency manager the copies of the plurality of updated database data as valid copies of the plurality of given database data in local memory;
sending by the coherency manager a single message to the other host computers invalidating local copies of the plurality of given database data on the other host computers;
receiving acknowledgement messages by the coherency manager from the other host computers that the local copies of the plurality of given database data have been invalidated; and
sending by the coherency manager an acknowledgement message of receipt of the copies of the plurality of updated database data to the first host computer.

11. A computer program product for providing coherent access to shared data in a shared database system, the computer program product comprising:
a computer readable storage medium having computer readable program code embodied therewith, the computer readable program code comprising:
computer readable program code configured to:
receive data indicating updates of a given database data from a first host computer in the shared database system through remote direct memory access (RDMA);
invalidate local copies of the given database data on other host computers in the shared database system through RDMA;
receive acknowledgements from the other host computers through RDMA that the local copies of the given database data have been invalidated; and
send an acknowledgement of receipt of the data indicating the updates of the given database data to the first host computer through RDMA.

12. The product of claim 11, wherein the computer readable program code configured to receive the data indicating the updates of the given database data is further configured to:
receive a copy of updated database data from the first host computer in the shared database system through RDMA, the copy of the updated database data comprising the updates to the given database data; and
store the copy of the updated database data as a valid copy of the given database data in local memory.

13. The product of claim 11, wherein the computer readable program code is further configured to:
receive a request for the valid copy of the given database data from a second host computer in the shared database system through RDMA;
retrieve the valid copy of the given database data from the local memory; and
return the valid copy of the given database data to the second host computer through RDMA.

14. The product of claim 11, wherein the computer readable program code configured to invalidate the local copies of the given database data on the other host computers in the shared database system through RDMA is further configured to:
send RDMA-write operations to the other host computers to alter memory locations at the other host computers to invalidate the local copies of the given database data;
immediately send to the other host computers second RDMA operations of the same memory locations at the other host computers; and
receive acknowledgements from the other host computers that the second RDMA operations have completed.

15. The product of claim 14, wherein the computer readable program code configured to immediately send to the other host computers the second RDMA operations of the same memory locations at the other host computers is further configured to:
immediately send to the other host computers RDMA-read operations to the same memory locations at the other host computers.

16. The product of claim 14, wherein the computer readable program code configured to immediately send to the other host computers the second RDMA operations of the same memory locations at the other host computers is further configured to:
immediately send to the other host computers second RDMA-write operations to the same memory locations at the other host computers.

17. The product of claim 11, wherein the computer readable program code configured to invalidate the local copies of the given database data on the other host computers in the shared database system through RDMA comprises:
determine a delayed acknowledgement feature is supported by the shared database system; and
send RDMA-write operations to the other host computers to alter memory locations at the other host computers to invalidate the local copies of the given database data,
wherein the delayed acknowledgement feature at the other host computers allows the sending of acknowledgements only after the RDMA-write operations fully complete in entire memory hierarchies of the other host computers.

18. The product of claim 14,
wherein the computer readable program code configured to send the RDMA-write operations to the other host computers to alter the memory locations at the other host computers to invalidate the local copies of the given database data is further configured to:
send in parallel the RDMA-write operations to the other host computers to alter the memory locations at the other host computers to invalidate the local copies of the given database data,
wherein the computer readable program code configured to immediately send to the other host computers the second RDMA operations of the same memory locations at the other host computers is further configured to:
immediately send in parallel to the other host computers the second RDMA operations of the same memory locations at the other host computers.

19. The product of claim 14, wherein the computer readable program code configured to send the RDMA-write operations to the other host computers to alter the memory locations at the other host computers to invalidate the local copies of the given database data is further configured to:
send a multi-cast RDMA-write operation to the other host computers to alter the memory locations at the other host computers to invalidate the local copies of the given database data.

20. The product of claim 11, wherein the computer readable program code is further configured to:
determine that RDMA operations are not supported in the shared database system;
receive one or more messages comprising copies of a plurality of updated database data from a first host computer, wherein the copies of the plurality of updated database data comprises updates to a plurality of given database data;
store the copies of the plurality of updated database data as valid copies of the plurality of given database data in local memory;
send a single message to the other host computers invalidating local copies of the plurality of given database data on the other host computers;
receive acknowledgement messages from the other host computers that the local copies of the plurality of given database data have been invalidated; and
send an acknowledgement message of receipt of the copies of the plurality of updated database data to the first host computer.

21. A system, comprising:
a database storing shared database data;
a plurality of host computers operatively coupled to the database; and
a coherency manager operatively coupled to the plurality of host computers, wherein the coherency manager comprises a computer readable storage medium having computer readable program code embodied therewith, the computer readable program code comprising computer readable program code configured to:
receive data indicating updates to a given database data from a first host computer of the plurality of host computers through remote direct memory access (RDMA), the copy of the updated database data comprising updates to a given database data;
invalidate local copies of the given database data on other host computers of the plurality of host computers in the shared database system through RDMA;
receive acknowledgements from the other host computers through RDMA that the local copies of the given database data have been invalidated; and
send an acknowledgement of receipt of the data indicating the updates to the given database data to the first host computer through RDMA.

22. The system of claim 21, wherein the computer readable program code configured to receive the data indicating the updates of the given database data is further configured to:
receive a copy of updated database data from the first host computer in the shared database system through RDMA, the copy of the updated database data comprising the updates to the given database data; and
store the copy of the updated database data as a valid copy of the given database data in local memory.

23. The system of claim 21, wherein the computer readable program code is further configured to:
receive a request for the valid copy of the given database data from a second host computer through RDMA;
retrieve the valid copy of the given database data from the local memory; and
return the valid copy of the given database data to the second host computer through RDMA.

24. A method for providing coherent access to shared data in a shared database system, the shared database system including a plurality of host computers, comprising:
updating a local copy of a given database data by a host computer;
determining a popularity of the given database data;
in response to determining that the given database data is unpopular, sending updated database data identifiers only to a coherency manager through remote direct memory access (RDMA); and
in response to determining that the given database data is popular, sending the updated database data identifiers and a copy of the updated database data to the coherency manager through RDMA.

25. The method of claim 24, wherein the determining the popularity of the given database data comprises:
determining if the given database data was originally stored in a local bufferpool of the host computer via a reading of the given database data directly from disk or from the coherency manager;
in response to determining that the given database data was originally stored in the local bufferpool of the host computer via the reading of the given database data direction from disk, determining the given database data to be unpopular; and
in response to determining that the given database data was originally stored in the local bufferpool of the host computer via the reading from the coherency manager, determining the given database data to be popular.
